(19) United States
(12) Patent Application Publication
(10) Pub. No.: US 2016/0110693 A1
(43) Pub. Date: Apr. 21, 2016

(54) COMPUTER SYSTEM AND COMPUTER-IMPLEMENTED METHOD FOR BILLING ADDRESS VERIFICATION WITHOUT ISSUER VERIFICATION

(71) Applicant: MASTERCARD INTERNATIONAL INCORPORATED, Purchase, NY (US)

(72) Inventors: Justin X. Howe, Oakdale, NY (US); Patrick R. Lowery, New York, NY (US); Clara Salazar, Manchester, MO (US)

(21) Appl. No.: 14/515,996

(22) Filed: Oct. 16, 2014

(51) Int. Cl. G06Q 20/10; G06Q 20/12; G06Q 20/40

(52) U.S. Cl. CPC G06Q 20/102; G06Q 20/4016; G06Q 20/12

(57) ABSTRACT

A computer implemented method for performing payment account billing address verification. The method comprises the steps of receiving an authorization request, including payment account information and billing address information, from a merchant. The authorization request is transmitted to an issuer associated with the payment account. At the same time, an address verification request is transmitted, including the payment account information and billing address information, to an outside service provider. The authorization response from the issuer and the results of the address verification address are received. An indication is made on the authorization response regarding the results of the address verification request, and the authorization response is transmitted to the merchant.

### CROSS-REFERENCE TO RELATED APPLICATIONS

None.

### FIELD OF INVENTION

The present disclosure relates to systems and methods for performing payment account address verification operations, and more specifically to systems and methods for performing payment account address verification operations which do not rely on address information obtained from a payment account issuer.

### BACKGROUND

The rapid growth of eCommerce, including online retail shopping, provides consumers and merchants the convenience of conducting transactions across the globe, without requiring any in-person interaction. These transactions may be performed by consumers accessing merchant-specific websites via the internet, or merchant-specific software applications previously downloaded onto their mobile devices. While offering a high level on convenience for both consumers and merchants alike, a distinct area of concern regarding these types of card not present transactions includes fraud prevention, as it is difficult to verify that, for example, a customer making an online payment account purchase is indeed who they purport to be.

Many systems have been developed with a goal of minimizing the risk of fraudulent eCommerce purchases. For example, many countries have adopted the use of address verification systems. These systems are tasked with confirming that a billing address of a payment account provided by a customer at the time of purchase matches a billing address stored in a database of the payment account issuer (e.g. an issuing bank). In this way, a would-be fraudulent purchaser must not only be in possession of a payment card, but moreover, must have knowledge of the correct billing address associated with the card in order to successfully complete an online transaction. However, as currently implemented, not all payment account issuers possess the required infrastructure or databases necessarily to perform these verification steps.

Accordingly, alternative systems and methods for verifying billing addresses associated with payment accounts for the purpose of fraud prevention are desired.

### SUMMARY

In one embodiment of the present disclosure, a computer implemented method for performing payment account billing address verification is provided. The method comprises the steps of receiving, by one or more computer processors, via a network, an authorization request from a merchant computer system, the authorization request including payment account information and billing address information obtained from a cardholder; transmitting, by the one or more computer processors, the authorization request to an issuer computer system associated with the payment account; transmitting, by the one or more computer processors, an address verification request, including the payment account information and billing address information, to a service provider computer system; receiving, by the one or more computer processors, an authorization response from the issuer computer system; receiving, by the one or more computer processors, a result of the address verification request from the service provider computer system; indicating, by the one or more computer processors, on the authorization response, the result of the address verification; and transmitting, by the one or more computer processors, the authorization response, including the result of the address verification, to the merchant computer system.

In another embodiment, a computer system for performing payment account billing address verification is provided. The system includes one or more computer processors and a memory in communication with the one or more processors and storing program instructions. The one or more processors are operative with the program instructions to: receive an authorization request from a merchant computer system, the authorization request including payment account information and billing address information obtained from a cardholder; transmit the authorization request to an issuer system associated with the payment account; transmit an address verification request, including the payment account information and billing address information to a service provider system; receive an authorization response from the issuer system; receive a result of the address verification request from the service provider system; and transmit to the merchant system the authorization response, including the result of the address verification.

In another embodiment, a computer system for performing payment account billing address verification and furnishing address data to an issuer system is provided. The system includes one or more computer processors and a memory in communication with the one or more processors and storing program instructions. The one or more processors are operative with the program instructions to: receive an authorization request from a merchant computer system, the authorization request including payment account information and billing address information obtained from a cardholder; transmit an address verification request, including the payment account information and billing address information to a service provider system; receive a result of the address verification request from the service provider system; transmit an authorization request to an issuer system associated with the payment account, including the result of the address verification request; receive an authorization response from the issuer system; and transmit to the merchant system the authorization response, including the result of the address verification.

### BRIEF DESCRIPTION OF THE DRAWINGS

FIG. 1 illustrates a system architecture within which some embodiments of the present disclosure may be implemented.

FIG. 2 is a functional block diagram of a card network or managing computer system in accordance with an exemplary embodiment of the present disclosure.

FIG. 3 illustrates a process flow diagram of a prior art process for verifying a billing address associated with a payment account.

FIG. 4 illustrates a process flow diagram of an exemplary alternative process for verifying a billing address associated with a payment account according to an embodiment of the present disclosure.

FIG. 5 illustrates a process flow diagram of another exemplary alternative process for verifying a billing address associated with a payment account according to another embodiment of the present disclosure.

FIG. 6 illustrates a data flow diagram for verifying a billing address associated with a payment account according to an embodiment of the present disclosure.

### DETAILED DESCRIPTION

It is to be understood that the figures and descriptions of the present disclosure have been simplified to illustrate elements that are relevant for a clear understanding of the embodiments described herein, while eliminating, for purposes of clarity, many other elements found in computing systems and wireless communication devices communicating with one or more remote computers or servers via a local, internet, cellular or satellite networks, as well as computer systems or mobile telephones running native or web-based applications or other software. However, because such elements are well known in the art, and because they do not facilitate a better understanding of the present invention, a discussion of such elements is not provided herein. The disclosure herein is directed to all such variations and modifications known to those skilled in the art.

A “payment account processing system”, “payment card processing system” or “credit card processing network” or “card network”, such as the MasterCard network exists, allowing consumers to use payment cards, or payment accounts, issued by a variety of issuers to shop at a variety of merchants. With this type of payment account or payment card, an account issuer or attribute provider, such as a bank, extends credit to a customer to purchase products or services. When a customer makes a purchase from an approved merchant, the account or card number and amount of the purchase, along with other relevant information, are transmitted via the processing network to a processing center, which verifies that the card has not been reported lost or stolen and that the card's credit limit has not been exceeded. In some cases, the customer's signature is also verified, a personal identification number is required or other user authentication mechanisms are imposed. The customer is required to repay the bank for the purchases, generally on a monthly basis. Typically, the customer incurs a finance charge for instance, if the bank is not fully repaid by the due date. The account or card issuer or attribute provider may also charge an annual fee. The payment card is a card that can be presented (on-line or in-person) by the cardholder (i.e., customer) to a merchant in order to make a payment. By way of example, and without limiting the generality of the foregoing, a payment card can be a credit card, debit card, charge card, stored-value card, or prepaid card or nearly any other type of financial transaction card. Payment accounts, as described herein, include any and all forms of non-card, cashless payments, including, for example, mobile, digital wallet, key fob, or direct carrier billing payments.

It is noted that as used herein, the term “customer”, “cardholder,” “card user,” and/or “card recipient” can be used interchangeably and can include any user who holds a payment card for making purchases of goods and/or services. References to cardholders, payment cards, and the like should also be understood to include users of any type of non-card, cashless payment account as described above. Further, as used herein in, the term “issuer” or “attribute provider” can include, for example, a financial institution (i.e., bank) issuing a card, a merchant issuing a merchant specific card, a stand-in processor configured to act on-behalf of the card-issuer, or any other suitable institution configured to issue a payment card. As used herein, the term “transaction acquirer” can include, for example, a merchant, a merchant terminal, an automated teller machine (ATM), or any other suitable institution or device configured to initiate a financial transaction per the request of the customer or cardholder.

As used herein, the term “processor” broadly refers to and is not limited to a single- or multi-core general purpose processor, a special purpose processor, a conventional processor, a Graphics Processing Unit (GPU), an Applications Processing Unit (APU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

Countries such as the United States, United Kingdom and Canada utilize the Address Verification System (AVS) for protecting against payment account fraud. The AVS is used to verify the billing address of an individual claiming to own a payment account. As will be understood by one of ordinary skill in the art, the system operates in response to an authorization request initiated by a merchant or acquirer, and compares a billing address (or a portion of the billing address) of the payment account provided by a customer with the billing address associated with the payment account on file with the issuer or issuing bank. More specifically, a customer may log on to a merchant website and begin a purchase transaction. This may include entering a billing address and payment account information. After submission of a payment, the merchant forwards the payment account information and billing address to a card network connection point or payment gateway in the form of an authorization request. The acquiring bank sends the address information to a payment network connection which then translates the billing address into an address key, which is forwarded to the card network. The card network transmits the authorization request to the card issuer. The card issuer will compare the address key to their billing address records associated with the payment account, and provide a response indicative of a match or non-match of the billing address information. The issuer will also provide a decision to approve or not to approve the transaction based on other factors, such as the status of the account (e.g. if there is a sufficient credit balance, has the card been reported stolen, etc.) An authorization response is provided from the issuer, through the card network, through the acquiring bank, before being returned to the merchant, wherein the transaction will ultimately be revealed to a customer as approved or declined.

Many international payment account issuing banks do not currently have the capability to perform the above-described billing address verification processing. Moreover, in addition to being a time-consuming process, implementing this functionality into their existing systems would require a significant outlay of resources. For example, issuers may not have maintained up-to-date records of the billing addresses of their cardholders. In order to implement an effective address verification system, cardholder billing addresses would have to be updated and verified. Moreover, software updates would be required for enabling, for example, the intake of relevant input data (e.g. address keys), performance of the described comparisons operations, and the generation and transmission of the authorization response. Further still, cardholder addresses may not be standardized in particular countries, creating additional problems in implementing these address verification capabilities.

Disclosed herein are processor-executable methods, computing systems, and related processing for verifying billing address data associated with a payment account, without the need to access billing address data from a card issuer. More specifically, in order to provide a dependable address verification service, a system must have access to a database containing reliable payment account number data, as well as the addresses of the holders of these payment accounts. In addition to card issuers, a number of other third party entities or service providers may also possess the required data for performing payment account billing address verification. By way of non-limiting example only, credit reporting agencies, such as Experian and TransUnion, operate in many countries and manage databases containing the required information, including card/account holder names, payment account numbers, and billing addresses necessary for performing address verification operations. Moreover, this information is generally stored in a standardized fashion, enabling efficient comparisons. Systems and methods set forth herein are operative to utilize these third party databases for performing the address verification portion of a credit transaction approval process.

In one exemplary embodiment, a merchant computer system intakes customer payment account data, including their billing address and account or card number, for completing an online transaction. The merchant system forwards this information to the acquiring bank, which transmits the data to the card network in the form of an authorization request. According to embodiments of the present disclosure, the card network may analyze the authorization request, and identify any transactions requiring alternative billing address verification processing according to embodiments of the present disclosure. The card network may also identify transactions which will be subject to existing AVS processing. More specifically, by way of non-limiting example only, the card network may analyze the submitted payment account number and determine if the bank identification number (BIN) contained therein corresponds to a bank residing in a country which performs traditional AVS processing. If so, the card network will forward the authorization request onto the card issuer for performing standard AVS and general approval processing. However, if the card network identifies that, for example, the residing country of the issuer does not provide traditional address verification services, the card network will begin performing an alternative address verification service on behalf of the issuer according to embodiments of the present disclosure.

According to one embodiment, upon a determination that alternative address verification processing must be performed, a card network will transmit the authorization request to the issuer for approval of the transaction independent of an address verification operation. This authorization may include, for example, ensuring that a payment card in question has not been stolen, that the account is in good standing, and that the account carries a sufficient balance to complete the transaction.

In order to perform the address verification processing according to embodiments of the present disclosure, the card network will access the databases of, for example, one or more credit reporting agencies, and search for an address corresponding to the payment account number included on the authorization request. In other embodiments, this step would include sending a request to the credit reporting agency, including the billing address and card number identified on the authorization request. The credit reporting agency would transmit a response to the card network in the form of a positive or negative response for a match between the billing address provided on the request and that stored in the credit reporting agency's database.

In one embodiment, once an issuer had completed its portion of the authorization response (e.g. verifying an account status), an authorization response would be returned to the card network. The card network would proceed to enter or populate a specific field in the authorization response with an indication of the results of the billing address comparison provided by the credit reporting agency. This may include providing a match code in the field, indicating if there is an address match. The match code may also provide an indication as to what degree of address match has been achieved. For example, current AVS processing supports postal code level matching, full street address level matching and exact text matching. Embodiments of the present disclosure may provide for these varying degrees of address matching reflected in the match code provided on the authorization response. A completed authorization response continues to the acquirer, and finally to the merchant for final transaction approval or denial.

In another embodiment of the present disclosure, a card network may delay transmitting the authorization request to the issuer until an address verification can be performed. Once an address verification has been confirmed via the third party provider (e.g. a credit reporting agency), the card network may place an address match indicator on the authorization request and forward the same to the issuer to complete the authorization (e.g. the account status authorization). In this way, an issuer may be provided with a verified billing address data associated with the payment account. This information may be used by the issuer for any purpose, such as for incorporation into their approval decision process or fraud models.

While the above embodiments describe the use of a credit reporting agency's database for performing address verification operations, it should be understood that any other sources of this information may be used without departing from the scope of the present disclosure. Other sources may include, by way of non-limiting example, databases of shipping companies which may possess payment account and corresponding address data. Other entities, such as merchants that ship products to customers, may have databases including customer payment card or other payment account data, as well as customer shipping address data, which may be employed in embodiments. Moreover, while the embodiments have been described in the context of a card network performing the steps of, for example, determining the need for alternative address verification processing, and acquiring an address verification from a third party provider, it should be understood that these steps may be performed by any of the systems described herein, including the merchant's computer system or the acquiring bank's computer system, without departing from the scope of the present disclosure.

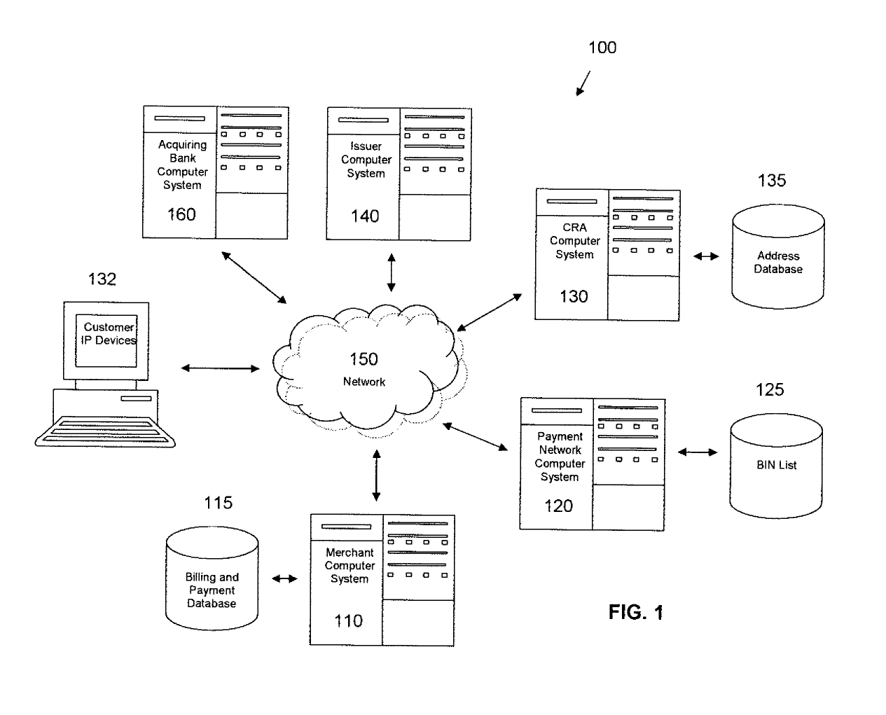

Referring now to FIG. 1, there is shown a high-level diagram illustrating an exemplary system for providing payment account address verification services which do not rely on address information obtained from a payment account issuer according to an embodiment of the present disclosure. As shown in FIG. 1, system 100 includes a merchant computer system 110. Merchant computer system 110 may transmit and receive data to and from at least one source, including one or more customer IP devices 132, such as a personal computer or mobile phone via, for example a network 150. Network 150 can be virtually any form or mixture of networks consistent with embodiments as described herein including, but not limited to, telecommunication or telephone lines, the Internet, an intranet, a local area network (LAN), a wide area network (WAN), virtual private network (VPN) and/or a wireless connection using radio frequency (RF) and/or infrared (IR) transmission to name a few. Data transmitted from customer IP device 132 to merchant computer system 110 may include identification of items to be purchased, purchase amounts, payment account data (e.g. a payment account number and card security code) and billing address information input by a customer during the course of purchase transaction. Merchant computer system 110 may store this and any other transaction-related data on a database 115.

Merchant computer system 110 may transmit some or all of this data, such as transaction amount, payment account data and billing address information, to an acquiring bank computer system 160 for generating an authorization request. Acquiring bank computer system 160 generates an authorization request, including transaction amount, the customer-input payment account number and billing address information, to a card or payment network computer system 120. Payment network computer system 120 is operative to, for example, identify any authorization requests which either: 1) will be subject to standard address verification processing; 2) require alternative address verification processing according to embodiments of the present disclosure; or 3) require no address verification (e.g. if the merchant does not require such verification). These determinations may be accomplished by for example, analyzing the BIN of the payment account number and determining if the issuing bank identified thereby provides existing address verification services. In one embodiment, payment network computer system 120 may access a database 125 which includes a listing of issuing banks and indications of their ability to provide address verification.

According to one embodiment of the present disclosure, if payment network computer system 120 determines that the card issuer is incapable of performing address verifications, or if payment network computer system 120 is unable to verify that the issuer provides such services, payment network computer system 120 may proceed with alternative address verification processing. In one embodiment, payment network computer system 120 will transmit a request, including the customer-input billing address and payment account information, to, for example, a credit reporting agency computer system 130, for address verification. Credit reporting agency computer system 130 may compare the provided payment account number and billing address information to an internal database 135 for the purpose of verifying the billing address. The results of the verification (e.g. a positive or negative indication of a match) may be provided to payment network computer system 120, and may be stored on database 125.

In one embodiment, along with the request for address verification transmitted to credit reporting agency computer system 130, payment network computer system 120 transmits the authorization request including at least the payment card information to the issuer computer system 140. Card issuer computer system 140 is configured to perform account verification operations, including for example, determining an account standing or status. The results of these verification operations are included on an authorization response, and returned to payment network computer system 120. Payment network computer system 120 receives the authorization response from card issuer computer system 140, and updates or supplements the authorization response with the address verification results provided by credit reporting agency computer system 130. The completed authorization response is transmitted to acquiring bank computer system 160 and subsequently to merchant computer system 110 for final purchase transaction approval or disapproval, and communication of purchase transaction approval or decline to customer IP device 132.

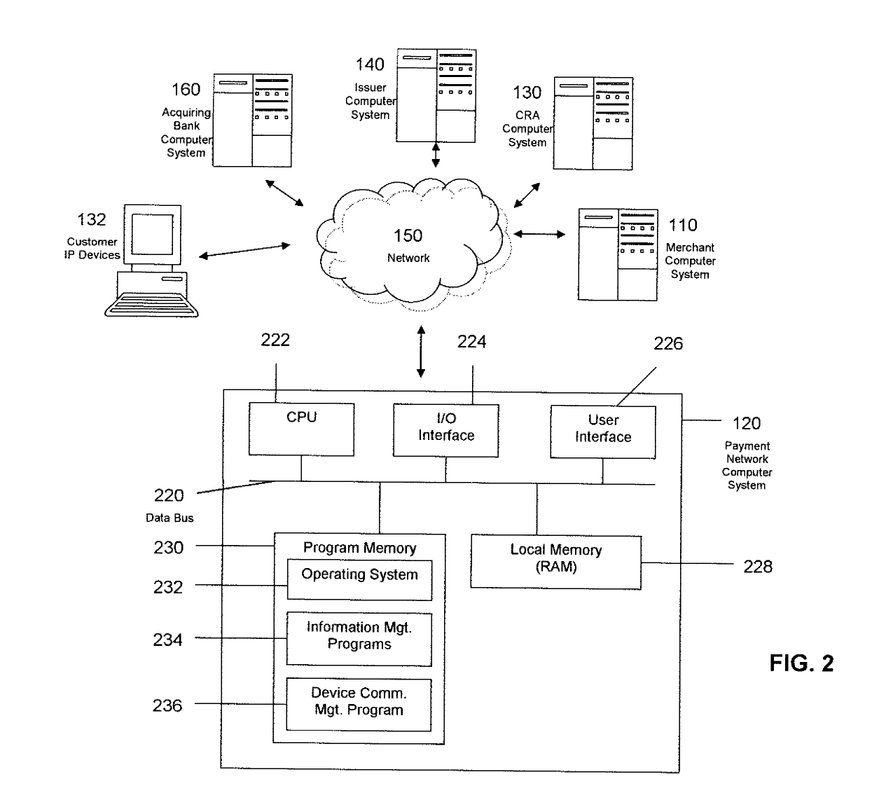

Referring now to FIG. 2, a more detailed embodiment of an exemplary payment network computer system 120 as described above with respect to FIG. 1 is shown. Payment network computer system 120 includes a data bus 220 providing communication among system components. One or more computer processors, designated by central processing unit (CPU) 222, is in communication via data bus 220 with components including program memory 230, local memory 228, user interface 226, and input/output interface 224. Program memory 230 stores programs including an operating system (OS) 232, which manages the computer hardware and provides common services for efficient execution of various logic circuitry including hardware, software and/or programs. Program memory 230 further stores one or more programs 234, which include computer-executable instructions to execute rules to perform the processing described herein, such as identifying authorization requests requiring alternative address verification processing according to embodiments of the present disclosure, managing communications between payment network computer system 120 and third party databases (e.g. credit reporting agency computer system 130), and modifying an authorization response to include address verification results. Payment network computer system 120 further includes device communication management program 236, which includes computer-executable instructions to manage communications, including communications of data to and from customer devices and external databases. The processor 222 (or CPU) carries out the instructions of computer programs, which operates and/or controls at least a portion of the functionality of payment network computer system 120. Program instructions may be loaded into local memory 228 for efficient and high-speed execution by CPU 222. Programs may be arranged in one or more modules, and functionality of programs may be implemented in program code that may be arranged as one or more programs or modules, which need not be stored on a same memory device, or executed by a single CPU.

Payment network computer system 120 further includes device input/output interface 224 configured to receive and output data and information to and/or from payment network computer system 120 from and/or to peripheral devices and networks operatively coupled to the system. Such networks may include exemplary network 150, which manages communications among, for example, customer IP devices 132, merchant computer system 110, payment network computer systems 120, credit reporting agency or third party computer system(s) 130, issuer computer system 140 and/or acquirer computer system 160. The I/O interface 224 may include a query interface configured to accept and parse requests customer IP devices 132 and any external systems and pass those requests to CPU 222 for processing using instructions of device communication management program 236.

The program memory 230 may include one or more of any form of data storage device including but not limited to electronic, magnetic, optical recording mechanisms, combinations thereof or any other form of memory device capable of storing data. The CPU 222 may be in the form of one or more computer processors, or may be in such forms as a distributed computing system, a centralized computing system, a network server with communication modules and other processors, or nearly any other automated information processing system capable of executing instructions stored in program memory. Payment network computer system 120 may be embodied as a data warehouse or repository for storing, managing and processing cardholder address verification related data received from a variety of sources on a periodic or continuous basis.

Each or any combination of the modules and components shown in FIGS. 1 and 2 may be implemented as one or more software modules or objects, one or more specific-purpose processor elements, or as combinations thereof. Suitable software modules include, by way of example, an executable program, a function, a method call, a procedure, a routine or sub-routine, one or more processor-executable instructions, an object, or a data structure.

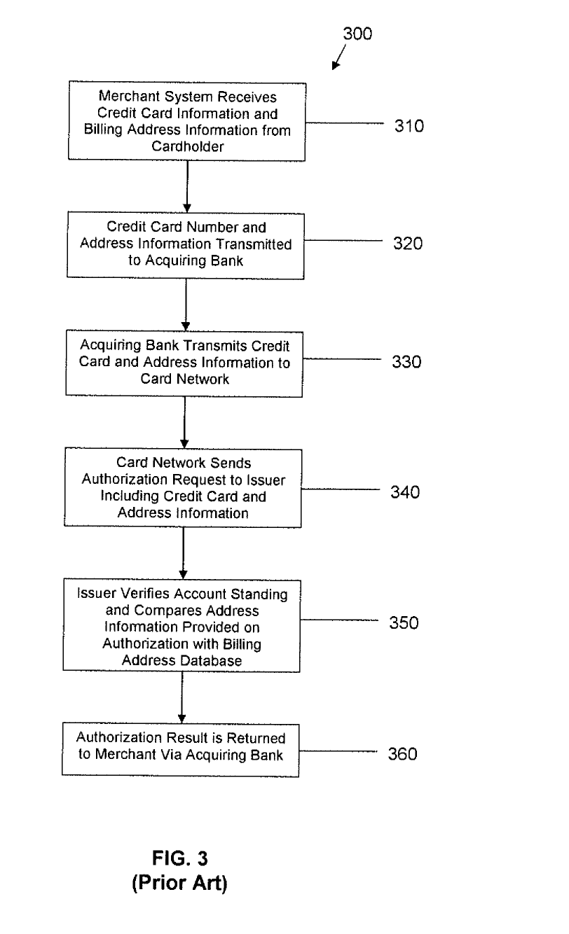

Referring generally to FIG. 3, an exemplary process flow diagram illustrating an address verification process 300 according to the prior art is shown. A merchant system receives 310 payment account information and billing address information from a cardholder. This information may be input by a customer through, for example, a merchant website at the payment stage of an online purchase transaction. The merchant system transmits 320 the payment account number and billing address information, as well as other information, such as transaction amount and security code data, to an acquiring bank computer system. The acquiring bank system transmits 330 an authorization request, including payment account and address information, as well as transaction amount and security code data, to a card network computer system associated with the payment account. The payment or card network system transmits 340 the authorization request to an issuer system, including the payment account and address information as well as transaction amount and security code data, using an authorization network. The authorization request may be in a standardized format for such authorization requests transmitted via the authorization network. The standardized format may include one or more fields for address data. The issuer system verifies 350 the standing of the account (not delinquent, not reported stolen, available credit at least the transaction amount, etc.), and compares the address provided with the authorization to its internal billing address database. The issuer system completes the authorization requests, indicating the results of these verification operations, and returns 360 an authorization response to the issuer system, via the authorization network. The card network system transmits the authorization response to the acquiring bank system. The acquiring bank system transmits the response to the merchant system. The merchant system then processes the transaction, in the event of an approval, and communicates approval to the customer, or communicates the denial to the customer.

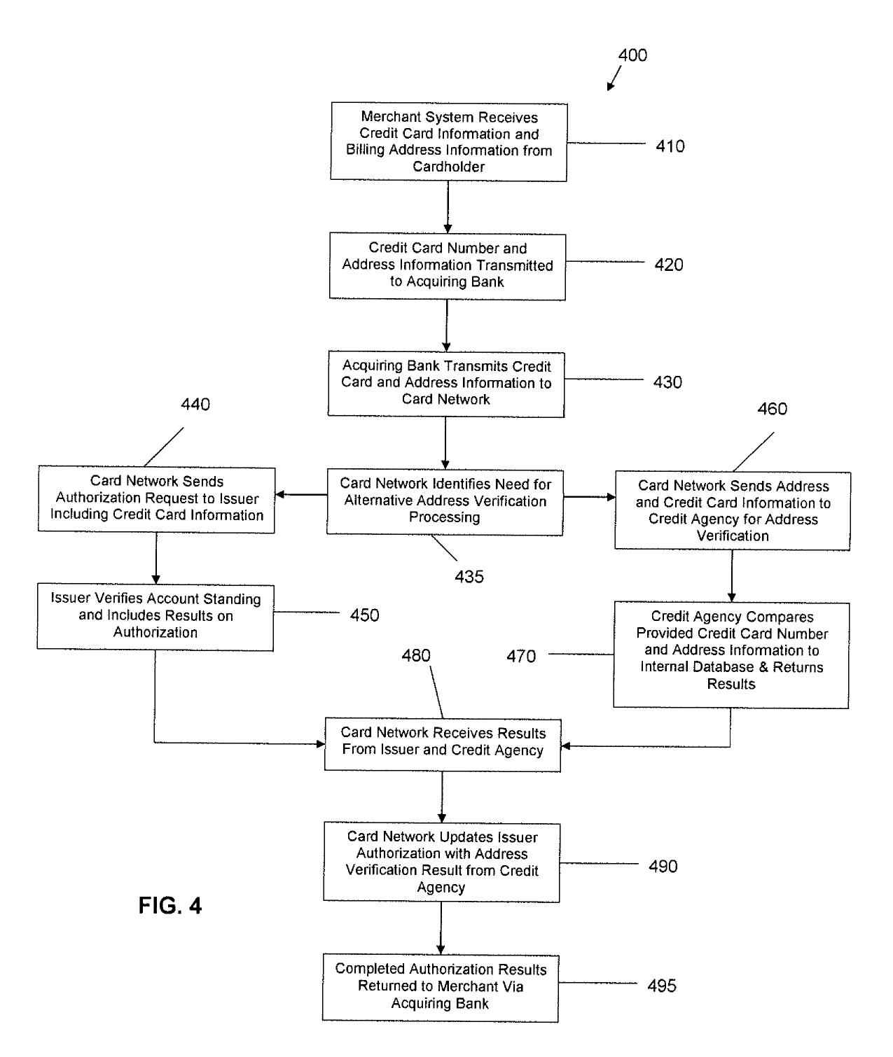

Referring generally to FIG. 4, an exemplary process flow diagram illustrating an address verification process 400 according to an embodiment of the present disclosure is shown. A merchant system receives 410 payment account information and billing address information from a cardholder. This information may be input by a customer through, for example, a merchant website at a payment stage of an online purchase transaction. The merchant system transmits 420 the payment account number and billing address information, as well as transaction amount and security code data, to an acquiring bank system. The acquiring bank system transmits 430 the payment account and address information, as well as transaction amount and security code data, in the form of an authorization request to a card network system associated with the payment account. The card network system determines whether alternative address verification processing is needed. Otherwise stated, the card network system identifies whether there is a need for alternative address verification processing 435. This determination may be accomplished by for example, analyzing the BIN of the payment account number and determining if the issuing bank identified thereby provides address verification services. In one embodiment, card network system may access a database which includes a listing of issuing banks and indications of their ability to provide address verification. Responsive to determining that alternative address verification processing is needed, such as a result of the database records indicating that the issuing bank is not capable of performing address verifications, the card network system transmits 460 the customer-input billing address and payment account information (e.g. in the form of a request for verification) to a third party computer system, such as a credit reporting agency computer system. This transmission may be accomplished via a network other than the card authorization network, and may use any suitable protocol, such as a virtual private network, ftp, secure shell, https, or other suitable secure transmission protocol. The third party computer system, responsive to receiving the request for verification, compares 470 the provided payment account number and billing address information to an internal database for the purpose of verifying the billing address, and returns the results (e.g. an indication of a match or a non-match) to the card network. In embodiments, the results may include, in addition to a match indication, an indication of a confidence level of a match. In embodiments, the match may include a postal code level match, an exact match, a street level match, and other levels of match, by way of non-limiting example.

In one embodiment, at or about the same time the card network transmits the request for billing address verification, the card network system transmits 440 the authorization request including at least the payment account information and transaction amount to the issuer computer system. The issuer computer system verifies 450 the account standing or status, includes the results on the authorization request, and returns an authorization response including these results to the card network. The authorization response may be one of an approval or a denial. The card network receives 480 the results from both the issuer and the credit reporting agency. The card network updates 490 the authorization response with the address verification results from the credit reporting agency system. The card network determines, based on a set of rules, an authorization response to provide to the merchant computer system. In general, if the issuer response is an approval, and the credit agency response is a match, then the card network provides an approval authorization response. If the issuer response is a denial, then the completed authorization response is returned 495 to the merchant system via the acquiring bank system.

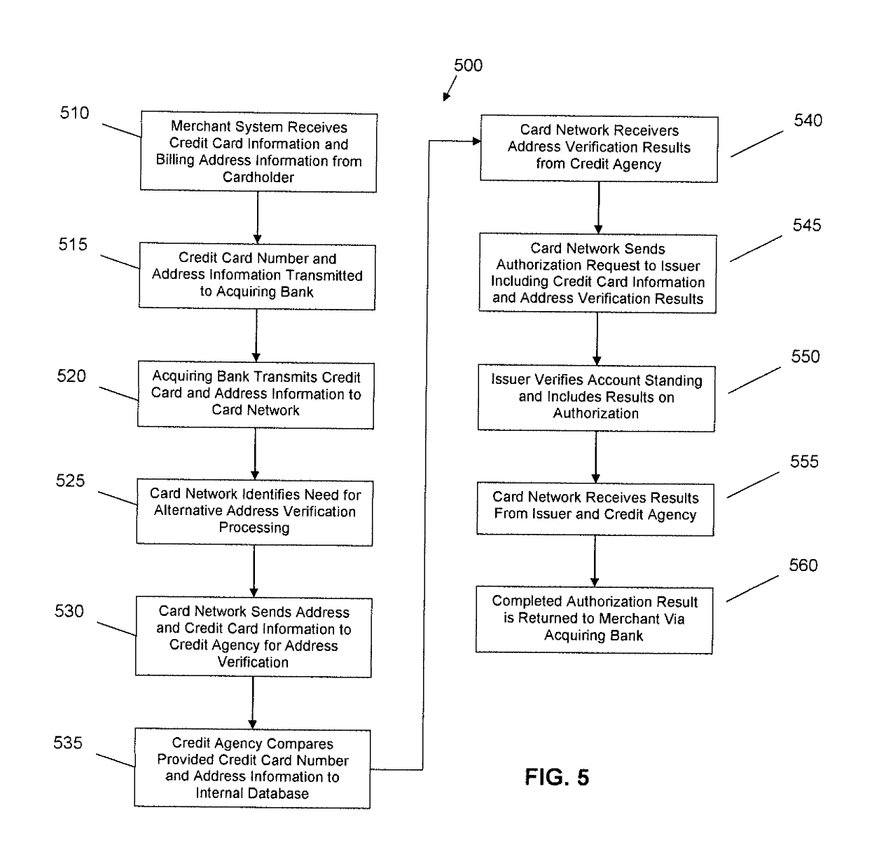

Referring generally to FIG. 5, an exemplary process flow diagram illustrating another address verification process 500 according to an embodiment of the present disclosure is shown. A merchant receives 510 payment account information and billing address information from a cardholder. This information may be input by a customer through, for example, a merchant website at the conclusion of an online purchase transaction. The merchant transmits 515 the payment account number and billing address information to an acquiring bank. The acquiring bank transmits 520 an authorization request, including payment account and address information, to a card network associated with the payment account. The card network identifies 525 a need for an alternative address verification processing. This may be accomplished via the above-described BIN analysis. If the issuer is incapable of performing address verifications, the card network sends 530 the address and payment account information to a third party, such as a credit reporting agency, for billing address verification. The third party or credit reporting agency compares 535 the provided payment account number and billing address information to an internal database for the purpose of verifying the billing address, and returns the results to the card network. The card network receives 540 the results from the credit reporting agency. The card network sends 545 the authorization request to issuer, including payment account information, as well as the results of the billing address verification. The issuer may use this address verification to, for example, update its own internal database with verified billing address data. The issuer proceeds to verify 550 the account standing or status, includes the results of this verification on an authorization response, and transmits the authorization response to the card network. The card network receives 555 the authorization response from the issuer, and returns 560 it to the merchant via the acquiring bank.

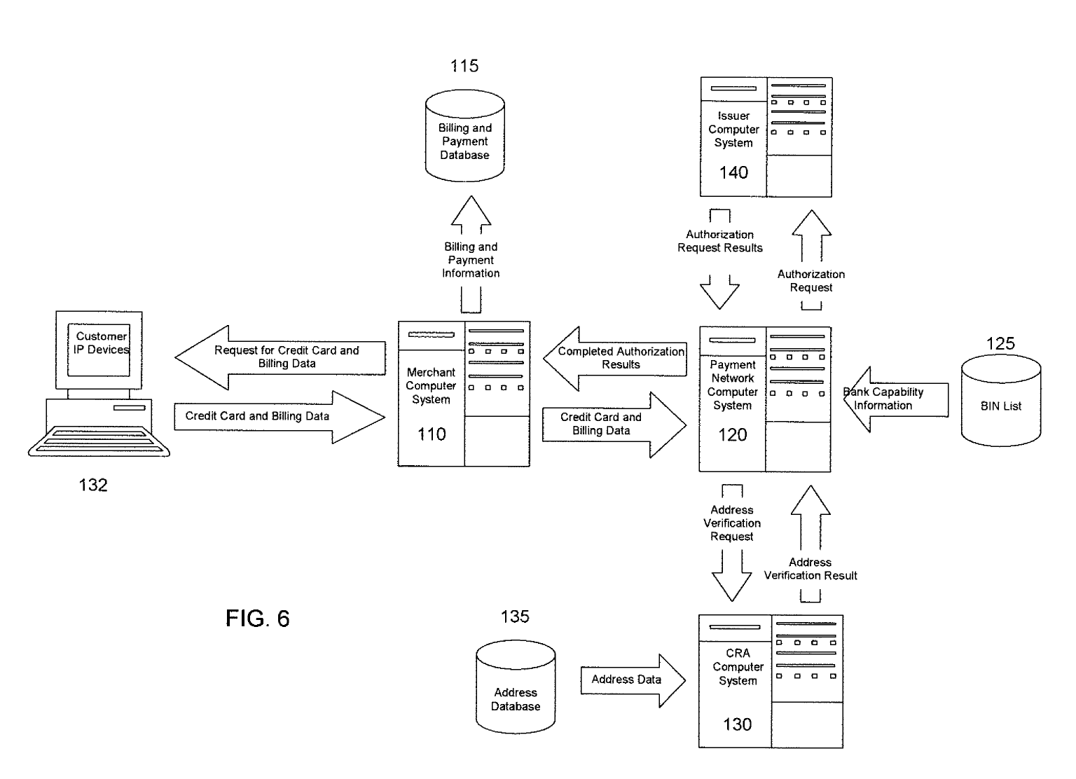

Referring to FIG. 6 an exemplary data flow diagram for verifying a billing address associated with a payment account according to an embodiment of the present disclosure is shown. Merchant computer system 110 may transmit and receive data to and from at least one source, including one or more customer IP devices 132, such as a personal computer or mobile phone via, for example a network. Data transmitted from customer IP device 132 to merchant computer system 110 may include the identification of items to be purchased, purchase amounts, payment account data (e.g. a payment account number and card security code) and billing address information input by a customer during the course of a purchase transaction. This information may be obtained in response to a request by merchant computer system 110. Merchant computer system 110 may store this and any other transaction-related data billing and payment database 115.

Merchant computer system 110 may transmit some or all of this data, such as transaction amount, payment account data and billing address information, to an acquiring bank computer system (not shown) for generating an authorization request, including transaction amount, the customer-input payment account number and billing address information. This information is subsequently transmitted to card or payment network computer system 120. Payment network computer system 120 is operative to, for example, identify any authorization requests which require alternative address verification processing according to embodiments of the present disclosure. This identification may be accomplished by, for example, analyzing the BIN of the payment account number for determining if the issuing bank identified thereby provides existing address verification services. In one embodiment, payment network computer system 120 may access a database 125 which includes a listing of issuing banks and indications of their ability to provide address verification.

If payment network computer system 120 determines that alternative address verification processing is required, payment network computer system 120 will transmit a request, including the customer-input billing address and payment account information to a third party computer system, such as credit reporting agency computer system 130, for address verification. Credit reporting agency computer system 130 may compare the provided payment account number and billing address information to an internal database 135 for the purpose of verifying the billing address. The results of the verification (e.g. a positive or negative indication of a match) may be provided to payment network computer system 120.

In one embodiment, along with the request for address verification transmitted to credit reporting agency computer system 130, payment network computer system 120 transmits the authorization request including at least the payment card information to the issuer computer system 140. Card issuer computer system 140 is configured to perform account verification operations, including for example, determining an account standing or status. The results of these verification operations are included on an authorization response, and returned to payment network computer system 120. Payment network computer system 120 receives the authorization response from card issuer computer system 140, and updates or supplements the authorization response with the address verification results provided by credit reporting agency computer system 130. The completed authorization response is transmitted to the acquiring bank computer system (not shown) and subsequently to merchant computer system 110 for final purchase transaction approval or disapproval, and communication of purchase transaction approval or decline to customer IP device 132.

The flow charts described herein do not imply a fixed order to the steps, and embodiments of the present invention may be practiced in any order that is practicable. In embodiments, one or more steps of the methods may be omitted, and one or more additional steps interpolated between described steps. Note that any of the methods described herein may be performed by hardware, software, or any combination of these approaches. For example, a non-transitory computer-readable storage medium may store thereon instructions that when executed by a processor result in performance according to any of the embodiments described herein. In embodiments, each of the steps of the methods may be performed by a single computer processor or CPU, or performance of the steps may be distributed among two or more computer processors or CPU's of two or more computer systems. In embodiments, each of the steps of the methods described with reference to FIGS. 3-5 may be performed by an applications processing unit (APU), which may include one or more processors. In embodiments, one or more steps of a method may be performed manually, and/or manual verification, modification or review of a result of one or more processor-performed steps may be required in processing of a method.

The embodiments described herein are solely for the purpose of illustration. Those in the art will recognize that other embodiments may be practiced with modifications and alterations limited only by the claims.

What is claimed is:

1. A computer implemented method for performing payment account billing address verification, the method comprising:
receiving, by one or more computer processors, via a network, an authorization request from a merchant computer system, the authorization request including payment account information and billing address information obtained from a cardholder;
transmitting, by the one or more computer processors, the authorization request to an issuer computer system associated with the payment account;
transmitting, by the one or more computer processors, an address verification request, including the payment account information and billing address information, to a service provider computer system;
receiving, by the one or more computer processors, an authorization response from the issuer computer system;
receiving, by the one or more computer processors, a result of the address verification request from the service provider computer system;
indicating, by the one or more computer processors, on the authorization response, the result of the address verification; and
transmitting, by the one or more computer processors, the authorization response, including the result of the address verification, to the merchant computer system.

2. The method of claim 1, wherein the service provider is a credit reporting agency.

3. The computer-implemented method of claim 1, further comprising, prior to transmitting the address verification request to the service provider, determining whether the bank identification number (BIN) contained therein corresponds to a bank residing in a country which performs traditional AVS processing, and responsive to determining that the BIN does not correspond to a bank residing in a country which performs traditional AVS processing, proceeding to transmitting the address verification request to the service provider.

4. The computer-implemented method of claim 1, wherein the result of the address verification comprises one of no match, exact match, street level match, and postal code level match.

5. The computer-implemented method of claim 1, wherein the transmitting, by the one or more computer processors, the authorization request to an issuer computer system associated with the payment account, comprises transmitting via an authorization network.

6. The computer-implemented method of claim 5, wherein the transmitting, by the one or more computer processors, an address verification request, including the payment account information and billing address information, to a service provider computer system, is via a network other than the authorization network.

7. The computer-implemented method of claim 1, wherein the transmitting and receiving the address verification request are performed prior to transmitting the authorization request, and, responsive to receiving a positive address verification request, the authorization request is transmitted, and responsive to receiving a negative address verification request, the authorization request is not transmitted.

8. A computer system for performing payment account billing address verification, the system comprising:
one or more computer processors;
a memory in communication with the one or more processors and storing program instructions, the one or more processors operative with the program instructions to:
receive an authorization request from a merchant computer system, the authorization request including payment account information and billing address information obtained from a cardholder;
transmit the authorization request to an issuer system associated with the payment account;
transmit an address verification request, including the payment account information and billing address information to a service provider system;
receive an authorization response from the issuer system;
receive a result of the address verification request from the service provider system; and
transmit to the merchant system the authorization response, including the result of the address verification.

9. The computer system of claim 8, wherein the service provider system is one of a credit reporting agency system and a merchant system.

10. The computer system of claim 8, wherein the one or more processors are further operative with the program instructions to: prior to transmitting the address verification request to the service provider, determine whether the bank identification number (BIN) contained therein corresponds to a bank residing in a country which performs traditional AVS processing, and responsive to determining that the BIN does not correspond to a bank residing in a country which performs traditional AVS processing, proceed to the transmitting the address verification request to the service provider.

11. The computer system of claim 8, wherein the one or more processors are further operative with the program instructions to: prior to transmitting the address verification request to the service provider, determine whether the bank identification number (BIN) contained therein corresponds to a bank residing in a country which performs traditional AVS processing, and responsive to determining that the BIN corresponds to a bank residing in a country which performs traditional AVS processing, transmit the authorization request, including billing address information, to the issuer system, and omit transmitting the address verification request to the service provider system.

12. The computer system of claim 8, wherein the result of the address verification comprises one of no match, exact match, street level match, and postal code level match.

13. The computer system of claim 8, wherein the one or more computer processors are operative with the program instructions to transmit the authorization request to the issuer computer system associated with the payment account via an authorization network.

14. The computer system of claim 13, wherein the one or more computer processors are operative with the program instructions to transmit the address verification request, including the payment account information and billing address information, to the service provider computer system, via a network other than the authorization network.

15. The computer system of claim 8, wherein the one or more computer processors are operative with the program instructions to transmit and receive the address verification request prior to transmitting the authorization request, and, responsive to receiving a positive address verification request, to transmit the authorization request, and responsive to receiving a negative address verification request, not transmit the authorization request.

16. A computer system for performing payment account billing address verification, the system comprising:
one or more computer processors;
a memory in communication with the one or more processors and storing program instructions, the one or more processors operative with the program instructions to:
receive an authorization request from a merchant computer system, the authorization request including payment account information and billing address information obtained from a cardholder;
transmit an address verification request, including the payment account information and billing address information to a service provider system;
receive a result of the address verification request from the service provider system;
transmit an authorization request to an issuer system associated with the payment account, including the result of the address verification request;
receive an authorization response from the issuer system; and
transmit to the merchant system the authorization response, including the result of the address verification.

17. The computer system of claim 16, wherein the one or more processors are further operative with the program instructions to: prior to transmitting the address verification request to the service provider, determine whether the bank identification number (BIN) contained therein corresponds to a bank residing in a country which performs traditional AVS processing, and responsive to determining that the BIN does not correspond to a bank residing in a country which performs traditional AVS processing, proceed to the transmitting the address verification request to the service provider.

18. The computer system of claim 16, wherein the result of the address verification comprises one of no match, exact match, street level match, and postal code level match.
